(19) United States
(12) Patent Application Publication
(10) Pub. No.: US 2021/0271945 A1
(43) Pub. Date: Sep. 2, 2021

(54) ENCODED DEVICE HAVING AN INTEGRATED GRAPHIC FEATURE

(71) Applicant: Hewlett-Packard Development Company, L.P., Spring, TX (US)

(72) Inventors: Nathan Shirley, Vancouver, WA (US); CHRISTINE DEWITT, Vancouver, WA (US); KELLI DEXHEIMER, Vancouver, WA (US); Edward Filby, London (GB); Matt Smith, London (GB); Bruno Dal Bo Silva, Vancouver, WA (US); Andrew Wagner, Houston, TX (US)

(73) Assignee: Hewlett-Packard Development Company, L.P., Spring, TX (US)

(21) Appl. No.: 17/256,453

(22) PCT Filed: Oct. 8, 2018
(86) PCT No.: PCT/US2018/054886

§ 371 Date: Dec. 28, 2020

(51) Int. Cl. G06K 19/06; B41J 3/28; B41J 3/01; B41J 3/36

(52) U.S. Cl. CPC G06K 19/06103; G06K 19/06093; B41J 3/36; B41J 3/01; B41J 3/28

(57) ABSTRACT

An example includes an encoded device having an exterior facade on which an integrated graphic design feature is provided. The graphic design feature includes a set of graphical elements, having one or multiple configurations, where each configuration is interpretable, by a viewing device, as a programmatic instruct or value, in accordance with a predefined encoding scheme.

### BACKGROUND

Devices are often designed to promote objectives of function and aesthetics. The design of a device can promote both function and aesthetics has often been accomplished through enhancements to form factor (e.g., miniaturization), selection of material for use as housing, and coloring or shading of exterior portions.

### BRIEF DESCRIPTION OF THE DRAWINGS

The disclosure herein is illustrated by way of example, and not by way of limitation, in the figures of the accompanying drawings in which like reference numerals refer to similar elements, and in which:

FIG. 1A illustrates an example encoded device having an integrated design feature.

FIG. 1B illustrates a closeup of a region B of FIG. 1A;

FIG. 2 illustrates an example encoded device system;

FIG. 3 illustrates a graphic design feature for an example encoding device;

FIG. 4 illustrates an example method for forming a graphic design feature on a shell of an encoded device;

FIG. 5 illustrates an example housing shell for an encoded device; and

FIG. 6 illustrates a computer system upon which aspects described herein may be implemented.

Throughout the drawings, identical reference numbers designate similar, but not necessarily identical elements. The figures are not necessarily to scale, and the size of some parts may be exaggerated to more clearly illustrate the example shown. Moreover, the drawings provide examples and/or implementations consistent with the description. However, the description is not limited to the examples and/or implementations provided in the drawings.

### DETAILED DESCRIPTION

An example includes an encoded device having an exterior facade on which an integrated graphic design feature is provided. The graphic design feature includes a set of graphical elements, having one or multiple configurations, where each configuration is interpretable, by a viewing device, as a programmatic instruct or value, in accordance with a predefined encoding scheme.

In other examples, a device system includes an encoded device having an integrated graphic design feature on an exterior facade, and a camera device that can interpret a configuration of a set of graphic elements of the design feature as an instruct or value, in accordance with a predefined encoding scheme.

Still further, other examples include a housing shell on which an encoded graphic design feature is provided on an exterior facade.

Among other benefits, examples enable manufacturers to utilize an encoded graphic design feature on their respective manufactured devices, in order to convey information to the user about the device, as well as to enhance or augment the use of the device. For instance, the computing device can utilize the encoded graphic design feature to implement an augmented reality (AR) recognition and tracking function. In the context of a printing device, examples enable the user to view information about their device, as well as to implement other operations and functionality, using an AR representation (e.g., a three-dimensional representation of their printing device on a captured image or scene) of their respective device.

Examples described herein provide that methods, techniques, and actions performed by a computing device are performed programmatically, or as a computer-implemented method. Programmatically, as used, means through the use of code or computer-executable instructions. These instructions can be stored in a memory resource of the computing device. A programmatically performed step may or may not be automatic.

Additionally, examples described herein can be implemented using programmatic modules, engines, or components. A programmatic module, engine, or component can include a program, a sub-routine, a portion of a program, or a software component or a hardware component capable of performing stated tasks or functions. As used herein, a module or component can exist on a hardware component independently of other modules or components. Alternatively, a module or component can be a shared element or process of other modules, programs, or machines.

Moreover, examples described herein can utilize specialized computing devices, including processing and memory resources. For example, examples described may be implemented, in whole or in part, on computing devices such as servers, desktop computers, cellular or smartphones, personal digital assistants (e.g., PDAs), laptop computers, printers, digital picture frames, network equipment (e.g., routers), wearable computing devices, and tablet devices. Memory, processing, and network resources may all be used in connection with the establishment, use, or performance of any example described herein (including with the performance of any method or with the implementation of any system). For instance, a computing device coupled to a data storage device storing the computer program and to execute the program corresponds to a special-purpose computing device. Furthermore, any computing systems referred to in the specification may include a single processor or may be architectures employing multiple processor designs for increased computing capability.

Furthermore, examples described herein may be implemented through the use of instructions that are executable by a processor. These instructions may be carried on a computer-readable medium. Machines shown or described with figures below provide examples of processing resources and computer-readable mediums on which instructions for implementing examples described can be carried and/or executed. In particular, the numerous machines shown with examples described include processor(s) and various forms of memory for holding data and instructions. Examples of computer-readable mediums include permanent memory storage devices, such as hard drives on personal computers or servers. Other examples of computer storage mediums include portable storage units, such as CD or DVD units, flash memory (such as carried on smartphones, multifunctional devices or tablets), and magnetic memory. Computers, terminals, network enabled devices (e.g., mobile devices, such as cell phones) are all examples of machines and devices that utilize processors, memory, and instructions stored on computer-readable mediums. Additionally, examples may be implemented in the form of computer-programs, or a computer usable carrier medium capable of carrying such a program.

### Device Description

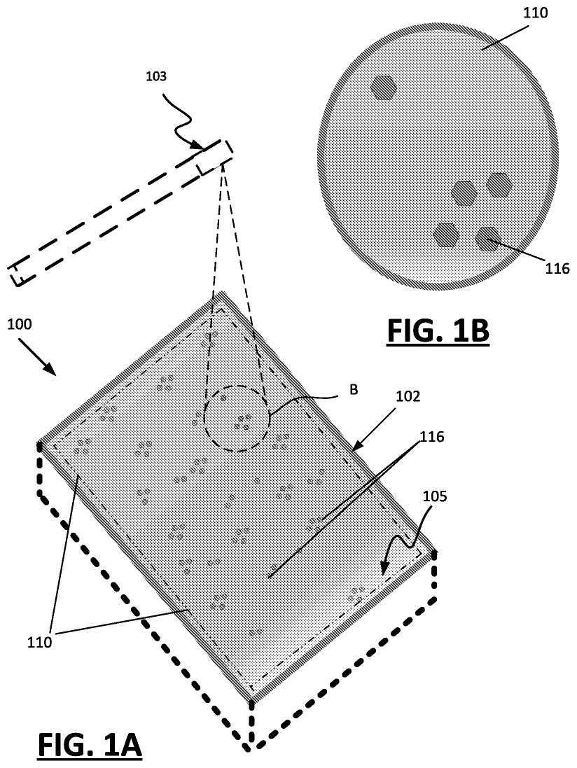

FIG. 1A illustrates an example encoded device having an integrated design feature. As illustrated in FIG. 1A, a device 100 includes a shell 102 to house at least a portion of the device 100. In some implementations, the device 100 can be an electronic device, such as a miniature or mobile photo printer. To illustrate, the device 100 can correspond to a mobile printer (e.g., “pocket printer” or “purse printer”) with shell 102 forming part of a form-factor in which photo-paper can be retained internally, and output to a slot or opening in an edge surface of the shell 102. In other implementations, the device 100 can correspond to a device having other function or purpose, such as a projector or audio output device.

The shell 102 can form an exterior facade 105 of the device 100. Based on implementation, the exterior facade 105 can be contoured or flat. An overall form-factor of the device 100 can vary in form or function based on considerations, such as a purpose or functionality of the device.

As shown, the exterior facade 105 can include an integrated graphic design feature 110 that spans a substantial portion (e.g., more than 50% of a length and/or width of the exterior facade 105) of a length and/or width of the shell 102. As an integrated aspect, examples provide that the graphic design feature 210 can be adhered, attached, or unitarily formed to the underlying surface. As described in greater detail, the graphic design feature 110 can provide an aesthetic purpose or function, by way of, for example, depicting a type of image and/or conveying imagery of a particular theme or mood. By way of example, the graphic design feature 110 can provide a background image having a colored theme. The graphic design feature 110 can includes a set of graphic elements 116, where the set of set of graphic elements individually, or collectively, have a configuration that correlates to a programmatic instruct or value of a predefined encoding scheme.

In examples, the graphic design feature 110 is integrated with the exterior facade 105. In variations, the graphic design feature 110 may also be unitarily formed with the exterior facade 105, such as through a manufacturing process where the shell 102 is created. The graphic design feature 110 is said to be unitarily formed if its creation on the shell 102 is through is irreversible. Thus, the graphic design feature can be said to be unitarily formed on the shell 102 if for example, its placement is permanent, so as to not be removeable unless material from the shell 102 is also removed.

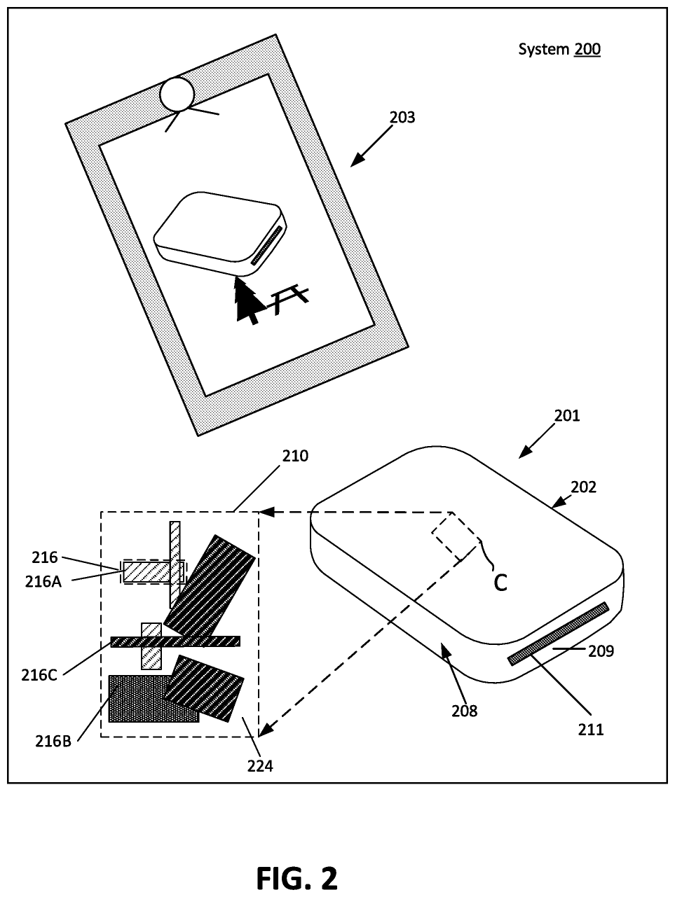

In some examples, the set of graphic elements 116 includes multiple individual graphic elements, with the configuration(s) of at least some graphic elements (e.g., cluster of discrete elements) being visually detectable and interpretable to a viewing device 103 as an encoded value or instruct. The viewing device 103 can correspond to, for example, a camera device (e.g., see camera device 203 of FIG. 2), and the configuration(s) of the set of graphic elements 116 can be selected to be detectable to a particular type of camera device, or to a camera device that is operable under a given setting to detect the configuration(s) of the set of graphical elements 116.

FIG. 1B illustrates a closeup of a region B on the exterior facade 105 of the device 100. As shown, the viewing device 103 can capture an image of a cluster of graphical elements 116 that appear on the exterior facade 105. In some implementations, multiple clusters of the graphic elements 116 can be provided on the exterior facade 105 as part of the graphic design feature 110, and the viewing device 103 can detect and interpret any one of the clusters of the graphic elements 116 as a corresponding instruction or value of an encoding scheme.

According to examples, the configuration of the graphic elements 116 may be based on a visually detectable characteristic of one or multiple graphical elements on the exterior facade 105. By way of examples, the visually detectable characteristic of individual graphical elements 116 can include a shape or dimension of the individual graphical elements, or a relative position of individual graphical elements 116 relative to one or multiple other graphical elements on the exterior façade 105. In some implementations, the visually detectable characteristic of one graphical element 116 is interpretable as an instruction or value of the encoding scheme. in other implementations, the visually detectable characteristic of multiple graphical elements 116 can be detectable and interpretable by the viewing device 103 as an instruct or value of the encoding scheme. As examples, the positioning of individual graphical elements 116 relative to one another, a visual characteristic of a cluster of graphical elements 116, and/or a variation amongst multiple graphical elements as to a particular visual characteristic of the element can be detectable and interpretable by the viewing device 103.

FIG. 2 illustrates an example encoded device system. As illustrated with an example of FIG. 2, an encoded device system 200 includes an encoded device 201 and a camera device 203. The encoded device 201 can be implemented in accordance with examples such as described with FIG. 1A and FIG. 1B. The camera device 203 can correspond to any camera equipped device with processing resources to detect and interpret graphical elements on an exterior surface or facade of the encoded device 01. In specific examples, the camera device 203 can correspond to a tablet, smart phone, feature phone, wearable device, or other form of mobile computing device, having a camera and processing resources to run an application or other logic for implementing computer vision processes.

In more detail, the encoded device 201 includes a shell 202 that provides an exterior facade 205 for the device. Based on implementation, the exterior facade 205 can be contoured or flat. An overall form-factor of the device 201 can vary, based on design objectives and/or intended functionality of the device. In examples, the device 201 can correspond to a mobile printer (e.g., “pocket printer” or “purse printer”) with the shell 202 forming a portion of the overall device housing 208. The device housing 208 can be designed to promote design objectives, such as dimensionality for portability, with the exterior facade 205 forming one of two major (e.g., greatest area) exterior surfaces of the device 201. As a printer device, the device housing 208 can be dimensioned to retain internal printer components and print media (e.g., photo-paper). The peripheral surfaces 209 of the housing 208 can include a slot 211 to eject print media after a print job is completed.

In examples, the shell 202 includes an integrated graphic design feature 210 that occupies a substantial portion of the exterior facade 205. For example, the graphic design feature 210 can occupy more than 50% of the surface area of the exterior facade 205. The graphic design feature 210 can be aesthetic in nature, such as in the form of a coloring scheme, pattern and/or image, so as to convey, for example, a theme or mood on the exterior facade 205 or other surfaces of the housing 208.

As described with examples, the graphic design feature 210 can be formed at least in part from a set of graphical elements 216, where the set of graphical elements 216 are aesthetic design elements that are provided on the exterior facade 205 in a configuration that is correlative to an instruct or value of a predefined encoding scheme. By way of example, the graphic design feature 210 can include background imagery 224, in the form of a coloring scheme, pattern or image, separate from graphical elements 216 that are visually distinct or separate from the background imagery 224. In examples, the graphical elements 216 can also be aesthetic, to further an aesthetic aspect of the background imagery 224 (e.g., mood, theme, etc.).

In examples, the configuration of select encoded graphical elements 216 can extend to a visually detectable characteristic of individual graphical elements 216. For example, the configuration of the set of encoded graphical elements 216 can correspond to a shape, dimension, or coloring (e.g., fill or line color) of one graphical element 216, where the element is present at a designated region of the exterior facade 205, or duplicated at multiple locations of the exterior facade 205. As an example, the visually detectable characteristic of an encoded graphical element 216 can correspond to a shape, such as a polygonal shape formed by adjoining lengths or linear segments. In variations, the encoded graphical element 216 can be duplicated on the exterior facade 205 so that multiple graphical elements include a common shape characteristic (e.g., characteristic of a polygon edge, or portion of polygon) that is correlative to an instruction or value of an encoding scheme. In other variations, an graphical element 216 that appears on the exterior facade 205 can be unique and interpretable separate or independent of other graphical elements 216 on the exterior facade 205 (or elsewhere on the device 201.)

The machine or program interpretable visual characteristics of polygonal graphical elements 216 can include, for example, presence or appearance hard edges (e.g., uniform edges, hard irregular polygonal edges, angle or aspect of adjoining lengths or linear segments), corners, or jagged lines As additional examples, the machine or program interpretable visual characteristics of polygonal graphical elements 216 can relate to arrangement and placement of individual graphical elements 216, such as position of individual graphical elements 216 relative to the background imagery 224, other graphical elements and/or structural features of the shell 202 or housing 208.

In other examples, the configuration of the graphical elements 216 can correspond to a visually detectable characteristic of multiple graphical elements. For example, multiple graphical elements 216 can be arranged into clusters and/or formed into patterns that are both aesthetic and encoded. In some examples, the graphic design feature 210 can include aesthetic graphical elements 216 of alternative configurations, such as shown by alternative graphical elements 216A, 216B, 216C, where the graphical elements 216 of each configuration are correlative to a corresponding programmatic instruct or value, independent and/or separate from the aesthetic aspects (e.g., coloring scheme, mood, theme, image) of other aspects of the graphic design feature 210, such as of the background imagery 224.

In some examples, the graphical elements 216 are visually detectable to humans and to camera device 203. To human vision, the graphical elements further an aesthetic aspect of the graphic design feature 210. The camera device 203, on the other hand, can execute, for example, a specific application that enables the camera device 203 to operate in a specialized mode for detecting graphical elements of a predetermined encoding scheme in a given object. When the camera device 203 operates in the specialized mode, the graphical elements 216 are detected through, for example, a computer-implemented vision process of the application, to interpret one or multiple instructions or values from the graphical elements 216.

In some examples, the camera device 203 can operate (e.g., using the application) to scan a surface of the 201 (e.g., exterior facade 205) to detect and interpret the set of graphical elements 216 as a set of instructions of a predetermined encoding scheme. In response, the camera device 203 can implement the set of instructions. A resulting function of the camera device 203 can relate to a characteristic or functionality of the encoded device 201. As shown by FIG. 2, an example provides that the camera device 203 implements augmented-reality functionality using the set of programmatic instructions that are interpreted or otherwise identified from the set of graphical elements 216 of the encoded device 201. As examples, the camera device 203 can implement the augmented reality functionality to depict the encoded device 201 in a scene that is provided by stored image, or alternatively, in a scene captured at that moment through a camera of the camera device 203. In variations, the camera device 203 can render content as an overlay with imagery captured through the device's camera or by stored images, where the content rendered relates to a functionality, setting, resource, or stored data of the encoded device 201. In specific examples, the camera device 203 uses the set of graphical elements 216 to identify an identifier of device 201 (e.g., make and model of device 201, unique identifier of device), and to depict an image or other content associated with the particular device (e.g., three-dimensional image of device in a three-dimensional environment).

As described, a visual appearance of the graphical elements 216 can further an overall aesthetic aspect of the graphic design feature 210. For example, a contrast between background imagery 224 and a color of individual graphical elements 216 can be relatively low, to provide a “low contrast” visual effect, where the contrast created by compared elements reflect a contrast comparison that is lower than stark contrasts, such as exist between black and white, or as between complementary hues (e.g., colors that are located on opposite sides of a color wheel, such as green and magenta, or blue and yellow). For instance, graphical elements 216 can be of a first color (e.g., dark grey) or hue (e.g., light blue), whereas background imagery 224 can be of a non-complementary color (e.g., black) or hue (e.g., dark blue). In some examples, different graphical elements 216 can have color or hue variations that are low (e.g., less than that of non-complementary colors or hues). For instance, one of the graphical elements 216 can be a light blue, whereas another of the graphical elements 216 can be a slightly darker blue. The relative contrast between the graphical elements 216 and also other aspects of the graphic design feature 210 (e.g., background imagery 224) can similarly be low, to parallel contrast between colors or hues that are not complementary (e.g., colors that are adjacent to one another on a color wheel, with similar brightness levels). As additional examples, background imagery 224 can be predominantly of a white hue, whereas graphical elements 216 can be of various grey hues, ranging from light to dark grey.

In yet other examples, the graphic design feature 210 can create an alternative visual effect, similar to a low contrast effect, between background imagery 224 and the graphical elements 216 through use of reflective material for the graphical elements. The resulting visual comparison between the graphical elements 216 and the background imagery 224 can generate a subtle, but aesthetic distinction that is also more easily captured through the camera device 203.

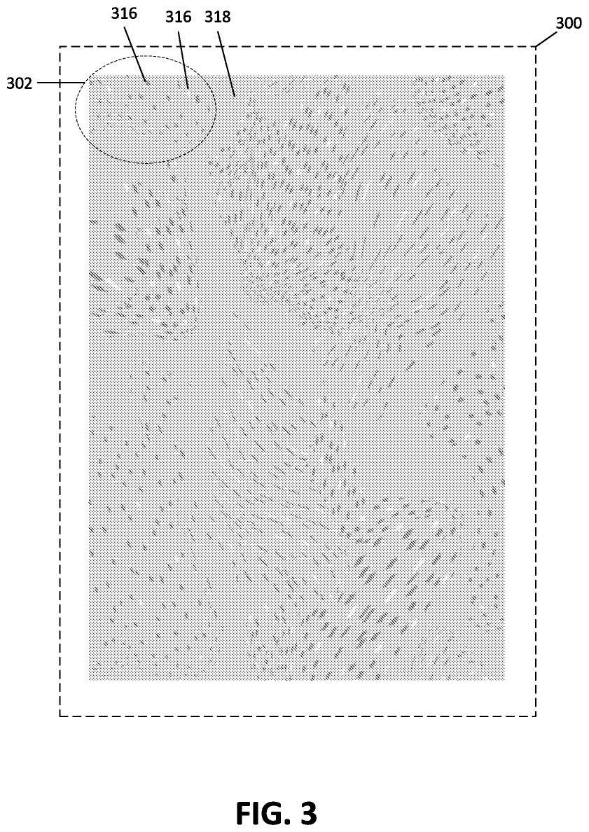

FIG. 3 illustrates a graphic design feature for an example encoded device. As shown, a graphic design feature 310 includes a pattern of graphical elements 316, provided over a background imagery 318 (e.g., whiteish color scheme). The graphic design feature 310 can be depicted on, for example the exterior facade of a device 300. The graphical elements 316 can, for example, appear as speckles over a substantially uniform background color scheme. The graphical elements 316 can include graphical elements which have, for example, a common hue or color, with alternating levels of reflectivity or brightness, so as to visually convey depth in a manner that is thematic and cohesive of the aesthetic aspect of the background imagery 318. In an example of FIG. 3, at least some of the graphical elements 316 can be graphical elements which are separately detectable and interpretable from other graphical elements and imagery of the graphic design feature 310.

According to some examples, the graphical elements 316 of a graphic design feature 310 can be based on a three-dimensional model that is later adhered onto a two-dimensional surface (e.g., shell 202 of device 201). Thus, the graphic design feature 310 can include a pattern of graphical elements 316 that are based on a three-dimensional model. In such examples, the pattern of graphical elements 316 can be clustered, as illustrated by cluster 302, based on the model transformation to the two-dimensional space. Within the individual clusters 302, examples provide that at least some of the individual graphical elements 316 include graphical elements that are detectable in interpretable by, for example, camera device 203.

In variations, a combination of multiple sets of graphical elements 316 can convey a particular programmatic instruct or values. For example, a combination of multiple clusters 302 that each include an encoded set of graphical elements 316 can convey a particular programmatic instruct or values.

### Methodology

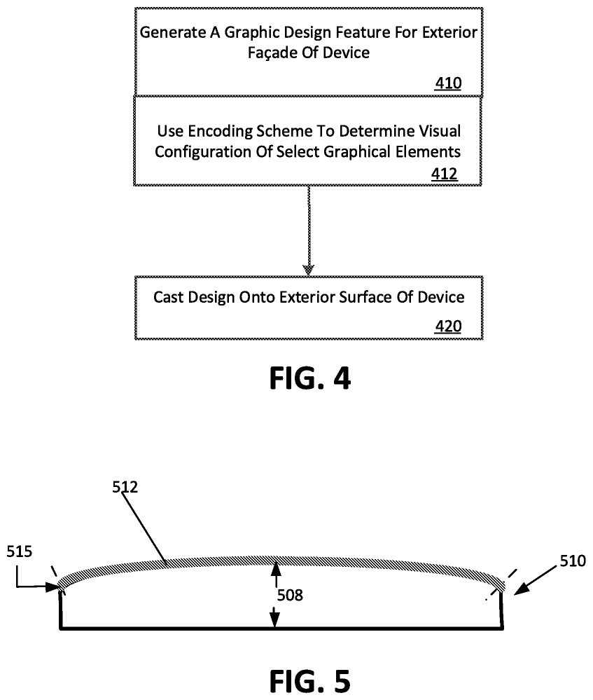

FIG. 4 illustrates an example method for forming a graphic design feature on a shell of an encoded device. In describing an example method of FIG. 4, reference may be made to reference characters representing features as shown and described with other figures, for the purpose of illustrating a step or sub-step of a method being described.

In some examples, a processor of, for example, a manufacturing printing system can be used generate a graphic design feature 110, 210, 310 (410). The graphic design feature 110, 210, 310 can include a number of graphical elements 116, 216, 316, such as polygonal elements and/or speckled elements. In examples, at least some of the graphical elements 116, 216, 316 are graphical elements that are separately detectable and interpretable from other imagery or elements of the respective graphic design feature 110, 210, 310. In this respect, the encoding graphical elements can convey a programmatic instruct or value that is separate from the overall graphic design feature 110, 210, 310, while at the same time being cohesive with an aesthetic aspect of the overall graphic design feature 110, 210, 310.

To implement encoding with the graphic design feature 110, 210, 310, a visual aspect of select graphical elements 116, 216, 316 can be formed to reflect a configuration, either individually with the particular graphical element, or in combination with one or multiple other graphical elements. By way of example, the individual graphical elements 116, 216, 316 can be encoded with designation of a shape (e.g., polygonal), shape portion (e.g., an edge configuration of a polygon), dimension, color or contrast (e.g., of fill or line element) or other visually detectable characteristic.

In variations, the contrast of a color scheme between a graphical element and another graphical element and/or to the background of a graphic design feature 110, 210, 310 can be selected so that the resulting pattern is aesthetically cohesive and subtle, and also detectable to a viewing device 103 or camera device 203.

In creating the graphic design feature 110, 210, 310, the manufacturing printing system can utilize a predefined encoding scheme to implement one of multiple possible configurations on at least some of the graphical elements 116, 216, 316 (412). The predefined encoding scheme can, for example, define multiple possible configuration for the use of the graphical elements 116, 216, 316, with each possible configuration being correlative to one of multiple possible values or instructions. The various configurations for graphic graphical elements can be as described with any of the examples described above. By way of example, a product line can be manufactured to include individual products (i.e., encoded devices) that are categorized to reflect a specific value that is interpretable from the particular configuration of graphical elements 116, 216, 316. As an addition or variation, the configuration of a given encoded device can reflect a series of values that collectively identify the particular device from other encoded devices.

Once the graphic design feature 110, 210, 310 is created, a manufacturing printing system can cast, or otherwise form the design onto one or multiple surfaces of a housing or shell that is being manufactured (420). Thus, for example, a manufacturing printing system can form the graphic onto a shell that is later used to assembly an encoded device (e.g., small-form factor printer).

In some examples, the manufacture printing system can utilize pad printing to adhere the graphic design feature onto a housing shell that is being manufactured for assembly to an encoded device. In other examples, the system can utilize digital printing process to print the graphic design feature 110, 210, 310 onto a surface of a housing, shell or assembled encoded device. In such examples, the graphic design feature 110, 210, 310, including graphical elements, are unitarily formed with at least a portion of a housing or shell for an encoded device.

FIG. 5 illustrates an example housing shell for an encoded device. An example housing shell 510 can be formed using, for example, an example method such as described by FIG. 4. In a variation of FIG. 5, the housing shell 510 can be formed as a separate component that can be combined with other components of a particular device, during a manufacturing and/or assembly process, to form an encoded device. In other examples, the housing shell 510 can be manufactured separately from a device that is to utilize the housing segment. In such examples, the housing shell 510 can be formed as an accessory or after-market component for another device, to enable a user to convert a purchased device into an encoded device, as described by various examples.

In examples, the housing shell 510 can include a thickness 508 that defines or otherwise provides an exterior facade 515. The thickness can be formed from various types of material, such as plastic, vinyl, rubber, composites, metals etc. According to some examples, the housing shell 510 can be subject a manufacturing printing process that causes a graphic design feature 512 to be unitarily formed on the exterior facade 515. The graphic design feature 512 can include graphical elements as described with various examples herein, to reflect both an aesthetic aspect or objective, and an encoding scheme.

### Hardware Diagram

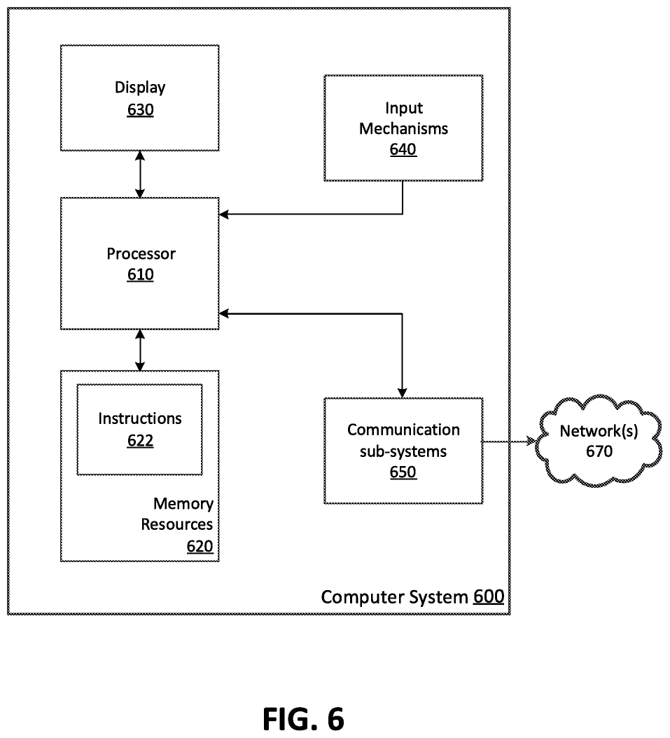

FIG. 6 is a block diagram that illustrates a computer system upon which examples described herein may be implemented. In some examples, a computing device 600 may correspond to a computer system that forms or is used with a manufacture printing system, to implement, for example, a method such as described with an example method of FIG. 6. The computing device 600 includes a processor 610 or combination of processors, memory resources 620, a display 630 (e.g., such as a touch-sensitive display device), a communication sub-systems 640 (e.g., for network communications), and one or multiple input mechanisms 660. In one example, at least one of the communication sub-systems 660 sends and receives cellular data over data channels and voice channels.

Memory resources 620 can store instructions 622 to implement, for example, an example method of FIG. 4. The processor 610 can execute instructions 622 to perform operations for implementing an example method of FIG. 4. For example, processor 610 can execute instructions 622 to generate a graphic design feature 110, 210, 310, including graphical elements 116, 216, 316. The processor 610 can further execute the instructions 622 to trigger manufacturing print operation on a housing or an encoded device.

Although specific examples have been illustrated and described herein, it will be appreciated by those of ordinary skill in the art that a variety of alternate and/or equivalent implementations may be substituted for the specific examples shown and described without departing from the scope of the disclosure. This application is intended to cover any adaptations or variations of the specific examples discussed herein.

What is claimed is:

1. An encoded device comprising:
a shell to form an exterior facade of at least a portion of the encoded device, wherein at least a portion of the exterior facade includes an integrated graphic design feature that is formed at least in part by a set of graphical elements, the set of graphical elements having a configuration that is interpretable, by a viewing device, to a programmatic instruct or value, in accordance with a predefined encoding scheme.

2. The encoded device of claim 1, wherein the set of graphical elements includes at least one graphical element that is configured by at least one visual characteristic that is detectable to a camera device.

3. The encoded device of claim 2, wherein the at least one visual characteristic of the graphical element includes at least one of a shape, dimension, contrast, color, surface variation or relative position on the exterior facade.

4. The encoded device of claim 1, wherein the set of graphical elements include multiple graphical elements that include at least one visual characteristic that is detectable to the viewing device, the at least one visual characteristic of the multiple graphical elements being interpretable collectively to the programmatic instruct or value.

5. The encoded device of claim 4, wherein the set of graphical elements are encoded by a variation to the at least one visual characteristic amongst the multiple graphical elements.

6. The encoded device of claim 4, wherein the set of graphical elements are configured by an arrangement amongst the multiple graphical elements.

7. The encoded device of claim 1, wherein the programmatic instruct is related to a function of the encoded device.

8. The encoded device of claim 1, wherein each graphical element of the set of graphical elements has a respective configuration that is based on a respective polygonal shape of that graphical element.

9. The device of claim 1, wherein the graphic design feature includes a colored scheme that occupies at least a substantial portion of the exterior facade.

10. The device of claim 9, wherein the graphic design feature includes a background imagery on which the set of discrete elements are provided.

11. The device of claim 10, wherein the set of graphical elements and the background imagery combine to provide a low contrast effect.

12. The device of claim 10, wherein the set of graphical elements are of a first hue, and wherein the background imagery is of a second hue that is not complementary to the first hue.

13. The device of claim 1, wherein the integrated set of discrete elements are unitarily formed with respect to the shell.

14. A device system comprising:
an encoded device comprising a shell that forms an exterior facade of at least a portion of the device, wherein at least a portion of the exterior facade incudes an integrated graphic design feature formed at least in part by a set of graphical elements that are interpretable under a predefined encoding scheme; and
a camera device to detect and interpret the set of discrete elements in accordance with the predefined encoding scheme.

15. A housing shell for a device, the housing shell comprising:
a thickness that defines an exterior facade, the thickness being formed from a first material;
a graphic design feature unitarily formed on the exterior facade, the graphic design feature including a set of graphical elements that form a foreground imagery, and a background imagery,
wherein the set of graphical elements have a configuration that is interpretable, by a viewing device, to a programmatic instruct or value, in accordance with a predefined encoding scheme.
